(19) United States
(12) Patent Application Publication
(10) Pub. No.: US 2017/0053729 A1
(43) Pub. Date: Feb. 23, 2017

(54) COMPOSITE MAGNETIC MATERIAL, COIL COMPONENT USING SAME, AND COMPOSITE MAGNETIC MATERIAL MANUFACTURING METHOD

(71) Applicant: Panasonic Intellectual Property Management Co., Ltd., Osaka (JP)

(72) Inventors: JUNICHI KOTANI, Hyogo (JP); NOBUYA MATSUTANI, Osaka (JP)

(21) Appl. No.: 15/305,941

(22) PCT Filed: Jul. 16, 2015
(86) PCT No.: PCT/JP2015/003593

§ 371 Date: Oct. 21, 2016

(30) Foreign Application Priority Data
Jul. 22, 2014 (JP) 2014-148437

(51) Int. Cl. H01F 27/255; H01F 1/36; H01F 41/02; H01F 1/147

(52) U.S. Cl. CPC H01F 27/255; H01F 1/14733; H01F 1/14791; H01F 1/36; H01F 41/0246

(57) ABSTRACT

A composite magnetic material includes first particles made of soft magnetic metal and second particles provided between first particles. Each of the second particles includes a first solid phase and a second solid phase. The composite magnetic material exhibits high magnetic characteristics.

### TECHNICAL FIELD

The present invention relates to composite magnetic material with excellent magnetic characteristics, a coil component using the composite magnetic material, and a method for manufacturing the composite magnetic material.

### BACKGROUND ART

PTL1 discloses a conventional composite magnetic material formed by mixing first particles, second particles, and insulating particles.

The composite magnetic material disclosed in PTL 1 does not exhibit sufficiently high magnetic characteristics.

### CITATION LIST

### Patent Literature

PTL 1: U.S. Patent Application Publication No. 2010/0289609

### SUMMARY

A composite magnetic material includes first particles made of soft magnetic metal and second particles provided between first particles. Each of the second particles includes a first solid phase and a second solid phase.

The composite magnetic material exhibits high magnetic characteristics.

### BRIEF DESCRIPTION OF DRAWINGS

FIG. 1 is a cross-sectional view of a composite magnetic material in accordance with the exemplary embodiment of the present invention.

FIG. 2A is a cross-sectional view of a second particle of the composite magnetic material in accordance with the embodiment.

FIG. 2B is a cross-sectional view of another second particle of the composite magnetic material in accordance with the embodiment.

FIG. 2C is a cross-sectional view of still another second particle of the composite magnetic material in accordance with the embodiment.

FIG. 3 is a cross-sectional view of a composite magnetic material in accordance with the exemplary embodiment.

FIG. 4 is a cross-sectional view of a further composite magnetic material in accordance with the embodiment.

FIG. 5 is a cross-sectional view of a further composite magnetic material in accordance with the embodiment.

FIG. 6 is an exploded perspective view of a coil component in accordance with the embodiment.

### DETAIL DESCRIPTION OF PREFERRED EMBODIMENT

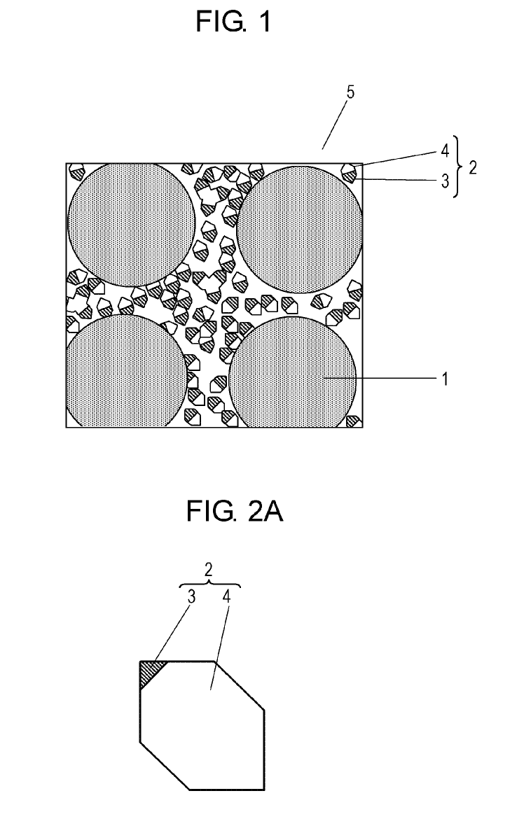

FIG. 1 is a cross-sectional view of composite magnetic material 5 according to an exemplary embodiment. Composite magnetic material 5 includes first particles 1 made of soft magnetic metal and second particles 2 provided between first particles 1. Each of second particles 2 includes first solid phase 3 and second solid phase 4.

Composite magnetic material 5 has a smaller number of voids formed between the particles than a composite magnetic material formed by simply mixing different two particles: first solid phase 3; and second solid phase 4. This allows first particles made of the soft magnetic metal to fill at a high filling rate.

Second particles 2 will be detailed below. In each of second particles 2, first solid phase 3 is made of insulator while second solid phase 4 is made of magnetic material. This configuration allows second solid phase 4 made of the magnetic material to fills at a high filling rate, not only first particles 1 made of the soft magnetic metal.

Further, first solid phase 3 made of the insulator prevents a contact between first particles 1 made of the soft magnetic metal, a contact between second solid phases 4 made of the magnetic material, and a contact between first particles 1 made of the soft magnetic metal and second solid phases 4 made of the magnetic material, hence suppressing an eddy current generated thereon.

Second solid phase 4 of the magnetic material may be metal, specifically, a simple substance of one metal selected from Fe, Co, and Ni. Fe, Co, and Ni have magnetic property, hence allowing composite magnetic material 5 to have high magnetic characteristics.

The metal may be Fe—Si based alloy, Fe—Si—Al based alloy, Fe—Si—Cr based alloy, or Fe—Ni based alloy. These alloys also have magnetic characteristics, hence allowing composite magnetic material 5 to have high magnetic characteristics.

Second particles 2, as shown in FIG. 1, may be physically bonded partly with each other. In this case, first solid phases 3 second particles 2 are bonded with each other, or second solid phases 4 of second particles 2 are bonded with each other. This physical bonding of second particles 2 enhances mechanical strength of composite magnetic material 5. First solid phases 3 may be bonded with second solid phases 4, thereby enhancing the mechanical strength of composite magnetic material 5.

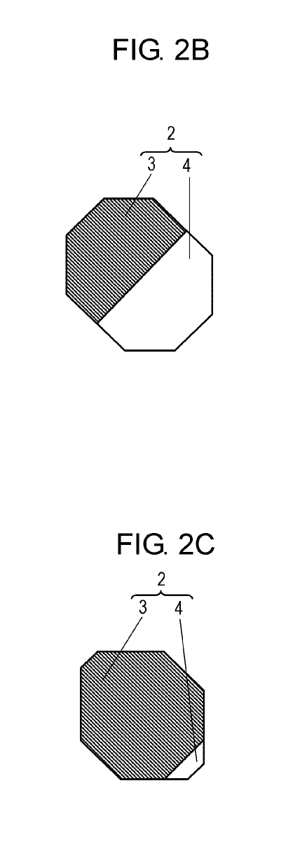

Second particles 2 according to the embodiment does not have a two-layer structure in which one solid phase is disposed over the surface of the other solid phase, but has a structure in which the solid phases is formed to inside the structure in cross sections of the particles. FIG. 2A is a cross-sectional view of the second particle of composite magnetic material 5 in accordance with the embodiment. FIG. 2B is a cross-sectional view of another second particle of composite magnetic material 5 in accordance with the embodiment. FIG. 2C is a cross-sectional view of still another second particle of composite magnetic material 5 in accordance with the embodiment. The cross sections of second particle 2 shown in FIG. 2A to FIG. 2C shows that first solid phase 3 and second solid phase 4 are formed not only on the surface of second particle 2 but also to the inside of the particle.

First solid phase 3 made of insulator is made of oxide. The oxide may contain at least one of Al, Cr, Ti, Mg, Si, and Ca, more in detail, Al₂O₃, Cr₂O₃, TiO, MgO, SiO₂, or composite oxide containing plural kinds of the above elements.

Composite magnetic material 5 according to the embodiment is formed by a thermal process in an inert atmosphere. This process will be described later.

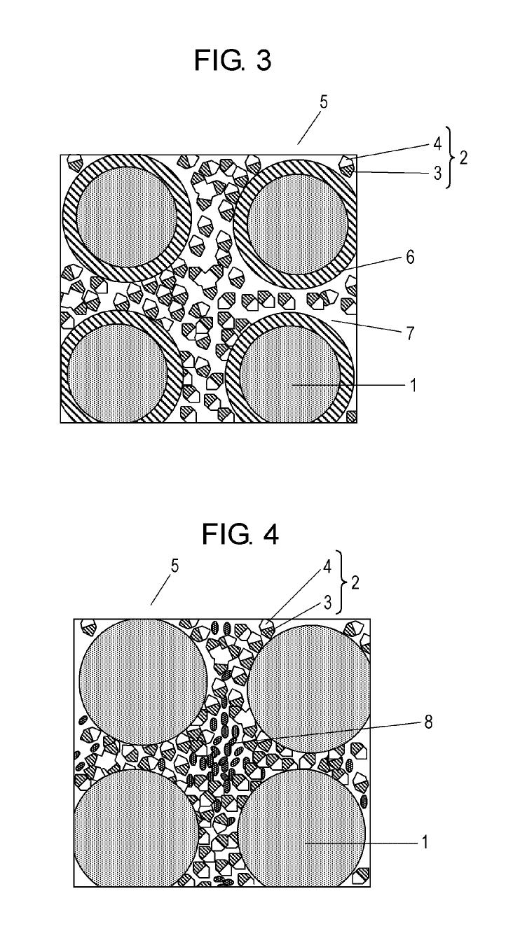

First particles 1 will be detailed below. FIG. 3 is a cross-sectional view of composite magnetic material 5 for particularly showing first particles 1. Oxidized film 6 containing Al, Cr, Ti, Mg, Si, or Ca may be formed on the surface of first particle 1 made of soft magnetic metal. Oxidized film 6 may be made of Al₂O₃, Cr₂O₃, TiO₂, MgO, SiO₂, or composite oxide containing the above elements. Oxidized film 6 over the surface of each of first particles 1 prevents first particles 1 made of the soft magnetic metal from contacting each other, or prevents first particles 1 made of the soft magnetic metal from contacting second solid phases 4 made of magnetic material, hence suppressing eddy currents generated thereon. The thickness of oxidized film 6 may preferably be equal to or larger than 10 nm and equal to or smaller than 500 nm.

Oxidized films 6 according to the embodiment are formed over the surfaces of first particles 1 such that a part of a metal contained in each of first particles 1 made of the soft magnetic metal is thermally processed to be oxidized, but it is not limited to; oxidized film 6 may be made of an oxide of a metal that is not contained in first particles 1 made of the soft magnetic metal.

FIG. 4 is a cross-sectional view of another composite magnetic material 5 in accordance with the embodiment. Composite magnetic material 5, as shown in FIG. 4, may further contain third particles 8 made of insulator between second particles 2.

Third particle 8 has a crystal structure different from that of first solid phase 3 and the second solid phase 4 of second particle 2. Third particle 8 may be made of various kinds of ferrite material; more in detail, Mn—Zn based ferrite, Ni—Zn based ferrite, Mg—Zn based ferrite, or spinel-type ferrite, such as hercynite. Spinel-type ferrite may be formed by adding some elements to hercynite as to have magnetic characteristics.

Besides, third particles 8 may be surrounded by second particles 2.

For example, in the case that FeAl₂O₄ is employed for a starting material in the process of forming second particles 2, first solid phase 3 made of oxide containing Al and second solid phase 4 made of Fe are formed by the thermal process, which will be described later.

To be specific, when FeAl₂O₄ is processed in an inert atmosphere at a temperature of 1000° C., the material of FeAl₂O₄ is partly reduced, so that first solid phase 3 made of oxide containing Al and second solid phase 4 made of Fe are formed. At this moment, not all the amount of FeAl₂O₄ is reacted, i.e., a part of FeAl₂O₄ is remained as it is, thereby providing third particles 8 made of insulating material. Third particles 8 made of insulating material remaining in the structure increases an insulating component for insulating between first particles 1 made of soft magnetic metal, accordingly suppressing an eddy current. The number per unit volume of third particles 8 may increase as the distance from first particles 1 made of soft magnetic metal increases.

Composite magnetic material 5, as shown in FIG. 3, may contain voids 7 between first particles 1 and second particles 2. Voids 7 may communicate with each other.

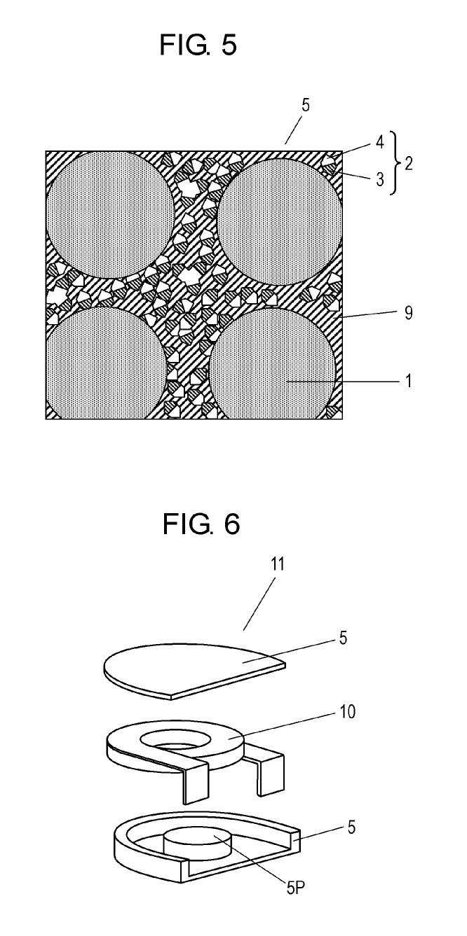

FIG. 5 is a cross-sectional view of still another composite magnetic material 5 according to the embodiment. In composite magnetic material 5 shown in FIG. 5, organic resin 9 fills voids 7. Organic resin 9 is impregnated into voids 7 and hardened to increase the bonding strength between first particles 1 made of soft magnetic metal and second particles 2, thereby increasing the mechanical strength of composite magnetic material 5. Besides, voids 7 communicated with each other allows organic resin 9 to easily impregnate into composite magnetic material 5, contributing to shortened lead time in the manufacturing process.

First particles 1 made of soft magnetic metal according to the embodiment will be described below.

A single substance of metal, at least one of Fe, Co, and Ni as magnetic material, is a specific example of the soft magnetic metal. The soft magnetic metal may be Fe—Si based alloy, Fe—Si—Al based alloy, Fe—Si—Cr based alloy, or Fe—Ni based alloy. The average particle diameter of first particles 1 made of soft magnetic metal may preferably be equal to or larger than 1 μm and equal to or smaller than 100 μm. The average particle diameter of first particles 1 of soft magnetic metal equal to or larger than 1 μm provides effects that, in manufacturing processes, first particles 1 is mixed without having aggregation with other materials. In dispersing, first particles 1 move apart from each other and form independent particles. Eddy-current loss in composite magnetic material 5 increases in proportion to the square of the size of a portion in which an eddy current flows. In order to reduce an effect of eddy currents, the average particle diameter of first particles 1 may preferably be equal to or smaller than about 100 μm. More preferably, the average particle diameter of first particles 1 may be equal to or larger than 3 μm and equal to or smaller than 50 μm. This range of the average particle diameter suppresses aggregation of first particles 1, suppressing generation of eddy currents.

As for the values of the average particle diameter, some errors may be observed between measurement methods; accordingly, the aforementioned preferable range of the average particle diameter can change in an error margin.

The average particle diameter of second particles 2 is not limited to a specific value, but may preferably be smaller than that of first particles 1. This configuration allows first solid phase 3 of oxide to exhibit high insulation effect between first particles 1 of soft magnetic metal, suppressing generation of eddy currents.

According to the embodiment, values of respective average particle diameters of first particles 1 and second particles 2 are measured at a cross section of composite magnetic material 5. The average particle diameter is calculated by obtaining diameters of 200 or more first particles 1 or second particles 2 at a cross section with an image analyzing device as equivalent circle diameters, and accumulating the diameters. The particle diameter at which the cumulative value corresponds to 50% of the total number of the particles is determined as the average particle diameter.

The material compositions of first solid phases 3, second solid phase 4, and oxidized film 6 of second particles 2 is observed by element assay of the cross section of composite magnetic material 5 with an X-ray micro analyzer (XMA).

FIG. 6 is a perspective view of coil component 11 including composite magnetic material 5. Coil component 11 includes coil 10 wound around at least a part of composite magnetic material 5. Coil 10 of the embodiment is wound around part 5P of composite magnetic material 5. Composite magnetic material 5 according to the embodiment contains magnetic material at a high filling rate and suppresses generation of eddy current, which provides coil component 11 with a small size and a low-profile structure.

A method for manufacturing composite magnetic material 5 according to the embodiment will be described below.

First, as first particles 1 made of soft magnetic metal, Fe—Si—Al alloy powder having an average particle diameter of 30 μm and composed of 10.0 parts by weight of Si, 5.0 parts by weight of Al, and the balance of Fe. The Fe—Si—Al alloy powder is prepared by gas atomization. Second particles 2 are made of FeAl₂O₄ powder and have an average particle diameter of 0.2 μm. A first additive amount, the amount of FeAl₂O₄ powder (second particles 2) to be added into 100 parts by weight of Fe—Si—Al alloy powder (first particles 1) is 15 parts by weight. The Fe—Si—Al alloy powder and the FeAl₂O₄ powder are mixed together and dispersed. Acrylic resin and organic solvent are mixed to the powders to form mixture, and then, the mixture is dispersed with a rotary ball mill, thereby providing the mixture material.

In the mixing and dispersing process of the Fe—Si—Al alloy powder (first particles 1), the FeAl₂O₄ powder (second particles 2), the acrylic resin, and the organic solvent, there is no particular order in mixing and dispersing.

As described above, the average particle diameter of composite magnetic material 5 is obtained by measurement on a cross section of composite magnetic material 5. However, the average particle diameter of the starting material of the Fe—Si—Al alloy powder and the FeAl₂O₄ powder is D50 values measured by laser diffraction scattering method.

Next, the mixture material is pressure-molded at pressure of 8 ton/cm², thereby providing a molded body having a predetermined shape.

Next, a thermal process is performed to the molded body in an inert atmosphere, that is, is heated for five hours at a temperature of 1200° C. in a nitrogen atmosphere as to release a distortion generated in the Fe—Si—Al alloy powder in the pressure molding. Further, the thermal process removes oxygen from the FeAl₂O₄ powder, thereby forming second particles 2 having two solid phases: first solid phase 3 of Fe and second solid phase 4 of oxide containing Al.

The temperature in the thermal process may preferably be equal to or higher than 1000° C. and equal to or lower than 1300° C., and the heating time may preferably be equal to or higher less than 0.5 hours and equal to or shorter than 6 hours.

When the thermal process is performed at temperatures lower than the above range (for example, at about 1000° C.), not the entire FeAl₂O₄ powder reacts and allows a part of the FeAl₂O₄ powder remain as third particles 8. Third particles 8 function as insulator that prevents the contact between first particles 1. In order to remain a part of the FeAl₂O₄ powder as third particles 8, the temperature at the thermal process may preferably be equal to or higher than 600° C. and equal to or lower than 1200° C., and the heating time may preferably be equal to or longer than 0.5 hours and equal to or shorter than 6 hours.

When a high-temperature thermal process in an oxygen atmosphere is previously performed to the Fe—Si—Al alloy powder before being mixed with other materials, oxidized film 6, is formed on the surfaces of first particles 1, as shown in FIG. 3. In order to form oxidized film 6 on the surfaces of first particles 1, the temperature at the thermal process may preferably be equal to or higher than 500° C. and equal to or lower than 1200° C., and the heating time may preferably be equal to or longer than 0.5 hours and equal to or shorter than 6 hours.

In composite magnetic material 5 according to the embodiment, as described above, each of second particles 2 includes first solid phase 3 made of insulator and second solid phase 4 made of magnetic material. This configuration decreases voids 7 formed between the particles, and allows composite magnetic material 5 to contain a lot of the first particles and a lot of second solid phase 4 as magnetic material.

Further, first solid phase 3 made of insulator prevents the contact between first particles 1 made of soft magnetic metal, the contact between second solid phases 4, and the contact between of first particles 1 and second solid phases 4, accordingly suppressing generation eddy currents.

### INDUSTRIAL APPLICABILITY

A composite magnetic material according to the embodiment has high magnetic characteristics and is useful for coil components having various types of magnetic material.

### REFERENCE MARKS IN THE DRAWINGS

1 first particle
2 second particle
3 first solid phase
4 second solid phase
5 composite magnetic material
6 oxidized film
7 voids
8 third particle
9 organic resin
10 coil
11 coil component

1. A composite magnetic material comprising:
a plurality of first particles made of soft magnetic metal; and
a plurality of second particles provided between the plurality of first particles,
wherein, each of the plurality of second particles includes a first solid phase and a second solid phase.

2. The composite magnetic material of claim 1, wherein the first solid phase is made of oxide.

3. The composite magnetic material of claim 2, wherein the oxide contains at least one of Al, Cr, Ti, Mg, Si, and Ca.

4. The composite magnetic material of claim 1, wherein the second solid phase is made of metal.

5. The composite magnetic material of claim 4, wherein the metal is one of Fe, Co, Ni, Fe—Si based alloy, Fe—Si—Al based alloy, Fe—Si—Cr based alloy, and Fe—Ni based alloy.

6. The composite magnetic material of claim 1, further comprising a plurality of third particles made of insulating material disposed between the plurality of second particles.

7. The composite magnetic material of claim 6, wherein the insulating material is spinel-type ferrite.

8. The composite magnetic material of claim 6, wherein a number of the plurality of third particles per unit volume of the composite magnetic material increases as being distanced away from the plurality of first particles.

9. The composite magnetic material of claim 1, wherein a plurality of voids is provided between the plurality of first particles and the plurality of second particles.

10. The composite magnetic material of claim 9, wherein the plurality of voids communicates with each other.

11. The composite magnetic material of claim 1, further comprising an organic resin disposed between the plurality of first particles and the plurality of second particles.

12. The composite magnetic material of claim 1, wherein an average diameter of the plurality of first particles is larger than an average diameter of the plurality of second particles.

13. The composite magnetic material of claim 1, wherein an average particle diameter of the plurality of first particles is equal to or larger than 1 μm and is equal to or smaller than 100 μm.

14. The composite magnetic material of claim 1, further comprising an oxidized film disposed on each of surfaces of the plurality of first particles.

15. A coil component comprising:
the composite magnetic material of claim 1; and
a coil wound around at least a part of the composite magnetic material.

16. A method for manufacturing a composite magnetic material, comprising:
providing a mixture material including a first powder made of the plurality of first particles, a second powder made of the plurality of second particles, and a resin mixed together;
providing a molded body by pressure-shaping the mixture material; and
forming a first solid phase and a second solid phase in each of the plurality of second particles by performing a thermal process on the molded body.

17. The method of claim 16,
wherein the thermal process is performed in an inert atmosphere, and
wherein the first solid phase is made of oxide, and the second solid phase is made of metal.

18. The method of claim 17,
wherein the oxide contains at least one of Al, Cr, Ti, Mg, Si, and Ca, and
wherein the metal is one of Fe, Co, Ni, Fe—Si based alloy, Fe—Si—Al based alloy, Fe—Si—Cr based alloy, and Fe—Ni based alloy.

19. The method of claim 16,
wherein the plurality of first particles contain metal,
the method further comprising, before said providing the mixture material, forming an oxidized film on each of surfaces of the plurality of first particles by oxidizing the metal of the plurality of first particles.
